(19) United States
(12) Patent Application Publication
(10) Pub. No.: US 2010/0030608 A1
(43) Pub. Date: Feb. 4, 2010

(54) SYSTEM AND METHOD FOR A CARBON CALCULATOR INCLUDING CARBON OFFSETS

(76) Inventors: Jason Kaminsky, Thousand Oaks, CA (US); Wolfram Liebchen, El Sobrante, CA (US)

Correspondence Address: MCGUIREWOODS, LLP, 1750 TYSONS BLVD, SUITE 1800, MCLEAN, VA, 22102, US

(21) Appl. No.: 12/510,756

(22) Filed: Jul. 28, 2009

Related U.S. Application Data
(60) Provisional application No. 61/084,465, filed on Jul. 29, 2008.

(51) Int. Cl. G06Q 10/00; G01C 21/00; G06Q 50/00; G06F 17/30; G06F 17/40

(52) U.S. Cl. 705/8; 701/213; 705/7; 707/3; 701/201; 707/E17.044; 707/E17.018; 707/E17.014

(57) ABSTRACT

A system and method for a carbon calculator including carbon offset determination is described. Distance and modes of transport may be used to determine carbon emissions and carbon offsets to compensate for the carbon emissions. The calculator may also provide trade-off comparisons between alternate modes of transportation such as air, truck, train, boat, and the like. The distance determination may involve actual mileage traversed in a shipment or may be calculated using GPS, for example.

This application claims benefit and priority to U.S. Provisional Application No. 61/084,465, filed Jul. 29, 2008 and entitled SYSTEM AND METHOD FOR A CARBON CALCULATOR INCLUDING CARBON OFFSETS, the disclosure of which is incorporated by reference herein.

### BACKGROUND OF THE INVENTION

1. Field of the Invention

The invention is directed to a system and method for a carbon calculator and, more particularly, to a system and method for a carbon calculator including offset costs.

2. Related Art

Environmental stewardship has become a significant issue in world social behavior and commerce. In particular, the negative affects of energy production and usage, such as green house gas and other carbon-related emissions, has generated increasing awareness of a need to limit these negative effects. People and businesses of all types have recognized that decreasing carbon footprints and carbon emissions is a desirable goal.

Many entities such as corporations, private businesses and individuals are partaking in various programs that have been organized to promote and manage in a responsible manner the balancing of a carbon footprint using carbon offsets. One type of carbon offset (typically a reduction of one metric ton of greenhouse gas emissions) is a Verified Emission Reduction (VER). A VER permits an organization, company or individuals to “balance” emissions of greenhouse gases (GHG) produced in one place by helping fund emission reductions that occur elsewhere. By purchasing a VER, for example, from carbon reduction projects, an entity provides needed revenue that allows these projects to become financially viable. For buyers of VERs, a low-cost practical solution to reducing their carbon footprint may be possible.

However, the mechanism(s) for identifying and quantifying the level of GHG emissions is still an evolving and maturing process. Therefore, a process and system for accurately, efficiently, and reliably quantifying the level of emissions to be offset would be a welcome addition for energy producing and energy consuming industries, and the public at large.

### SUMMARY OF THE INVENTION

The invention addresses the shortcoming in the prior art and provides a system and method directed to curing the problems in the prior art including accurately, efficiently, and reliably quantifying the level of emissions to be offset.

In one aspect, a computer-implemented method for computing carbon emissions for transporting a shipment includes calculating carbon emissions for a first mode of transportation by accessing a database configured to store at least carbon emission related data, determining a carbon offset cost for the first mode of transportation and updating the database and outputting total emissions and offset costs for the first mode of transportation to provide a basis to reduce the effects of carbon emissions for the first mode of transportation.

In another aspect, a system to compute carbon emissions related to transportation of a shipment is provided. The system includes a distance determination module embodied in a computer system configured to determine a distance for a shipment between an origination and a destination using a computer database configured with distance data, a transport mode selection module embodied in a computer system to distinguish between different transport modes and a carbon emission determination module embodied in a computer system configured to access the computer database and determine a carbon footprint for at least one selected transport mode based on the determined distance in the computer database and a weight of the shipment, the computer database accessible by the distance determination module, the transport mode selection module and the carbon emission determination module wherein the carbon emission determination module updates the computer database with the carbon footprint to be used to assist in reducing carbon emissions.

Additional features, advantages, and embodiments of the invention, like additional transport modes and countries, may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIGS. 1A and 1B are flow diagrams showing steps of an exemplary process performed according to principles of the invention;

FIGS. 2A and 2B are flow diagrams showing the steps of FIGS. 1A and 1B, but showing additional data resources;

FIG. 3 is an exemplary output of a carbon calculator configured to calculate carbon emissions and related offset costs, according to principles of the invention; and

FIG. 4 is a flow diagram showing steps of an exemplary process performed according to principles of the invention.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is noted that as used herein and in the appended claims, the singular forms “a,” “an,” and “the” include the plural reference unless the context clearly dictates otherwise. Thus, for example, a reference to “an address” is a reference to one or more addresses and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

The invention generally includes a system and method that provides for a calculator that calculates carbon emissions for transport modes such as for truck transport, rail transport, sea transport and air transport in the United States and world-wide. The calculator may calculate the environmental effect (measured in CO₂ equivalents) of shipments. The calculator configured according to principles of the invention and the associated steps performed in accordance with the principles of the invention may be incorporated into the operations of a supply chain company, a transportation provider, a shipper, or the like, and/or provided as a customer satisfaction/added value feature to a customer base.

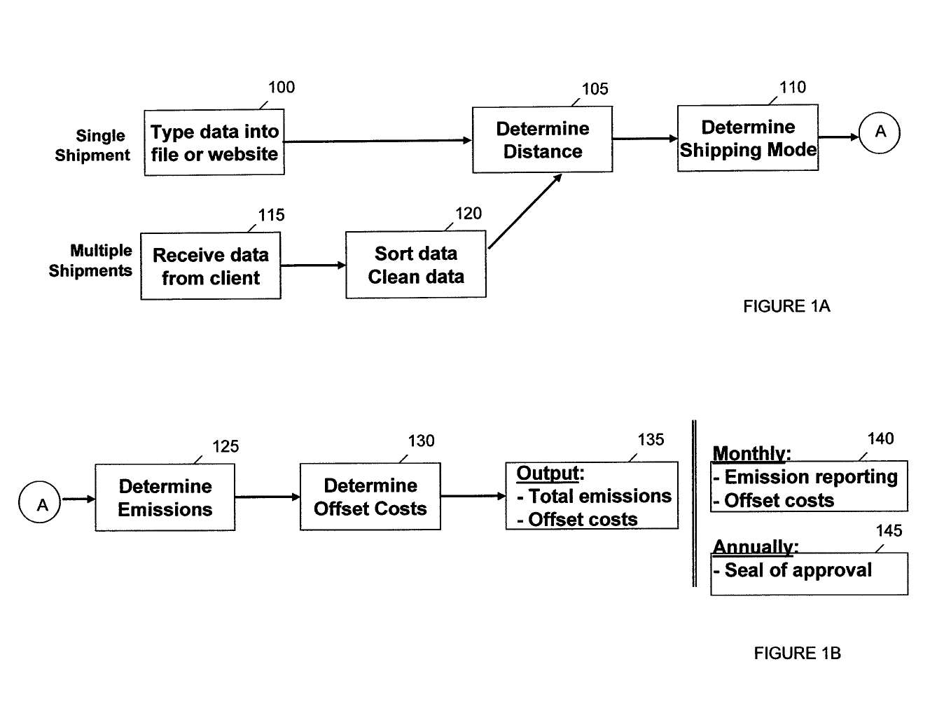

FIGS. 1A and 1B are flow diagrams showing steps of an embodiment performed according to principles of the invention. The flow diagrams of FIGS. 1A and 1B (and all other flow diagrams herein) may also be a block diagram of the components or modules for performing the steps thereof, including, but not limited to, for example, hardware, software or any combinations thereof. The components may execute on an appropriate computer medium, including, for example, a computer processing platform, an electronic circuit, and/or stored in a computer readable storage or memory such as a hard drive, a flash drive, a ROM, a RAM, a CD, a DVD, or the like.

The exemplary process may have multiple starting points, in this example either step 100 or step 115. At step 100, which is a starting point for a single shipment, a user may enter shipping information into a file or a website to describe the details of a shipment such as origination information, weight, desired service level, destination, zip codes, and the like. The process may continue at step 105.

Alternatively, the process may begin at step 115, for example, when multiple shipments may be involved. Data concerning the multiple shipments may be received from a client, preferably by electronic conveyance such as email, file transfer or website posting. The information may be conveyed perhaps by a CD or a data file containing the appropriate shipping information. The data may include shipment information, one or more zip codes of origin(s) and destination(s), a weight or weights, a service level parameter(s), a shipment identifier, and the like. At step 120, the shipment information may be sorted and “cleaned” to ensure correct and/or valid data.

At step 105, the distance may be determined from originating point(s) to destination(s). This may include geo-coding of each origin and destination zip code (longitude and latitude based on GPS coordinates, for example). As additional sub-steps, determination may also include the direct distance (point-point) between each zip-code pair. Moreover, conversion of the direct distance to actual distance may be determined through the use of distance adjustment factors. Adjustment factors may be based on sample shipments (e.g., actual traversed mileage for a shipment) that result in actual adjustments. For example, for truck movements, a detailed, statistically valid analysis has shown that an average adjustment factor of 21% is a feasible approximation for shipments in the continental 48 states of the US. For air shipments, specific mileage for pickup and delivery (e.g., to and from the airport) may be added.

At step 110, a shipping mode may be determined. This may be based on the desired level of service such as “same day,” “next day,” 2-day,” “3-day,” “deferred”, or the like, transit times. In combination with the distance calculated previously, a determination of whether or not a particular shipment has likely moved via truck or plane may be made.

At step 125, emissions may be determined for trucks and planes, taking into account the different emission factors of flights that are short haul, medium distance, or long haul, and emission factors of trucks. All factors are provided by the World Resource Institute and World Business Council for Sustainable Development (WRI/WBCSD) Greenhouse Gas (GHG) Protocol Initiative organization, and therefore are verified and widely/freely usable. At step 130, offset costs may be determined. This may include multiplying the weight and distance (ton miles) with emission factors, adding up the total (as appropriate), and multiplying the total with the offset cost as provided by a 3rd party verified outside partner (such as 3Degrees, Inc. for example). At step 135, an output may be generated with total emissions and offset costs. The output may be stored in a computer database for later recall and/or use in reducing carbon emissions. At step 140, a combined or aggregated monthly emission reporting may be generated perhaps including total offset costs. At step 145, a seal of approval for compliance may be issued to participants.

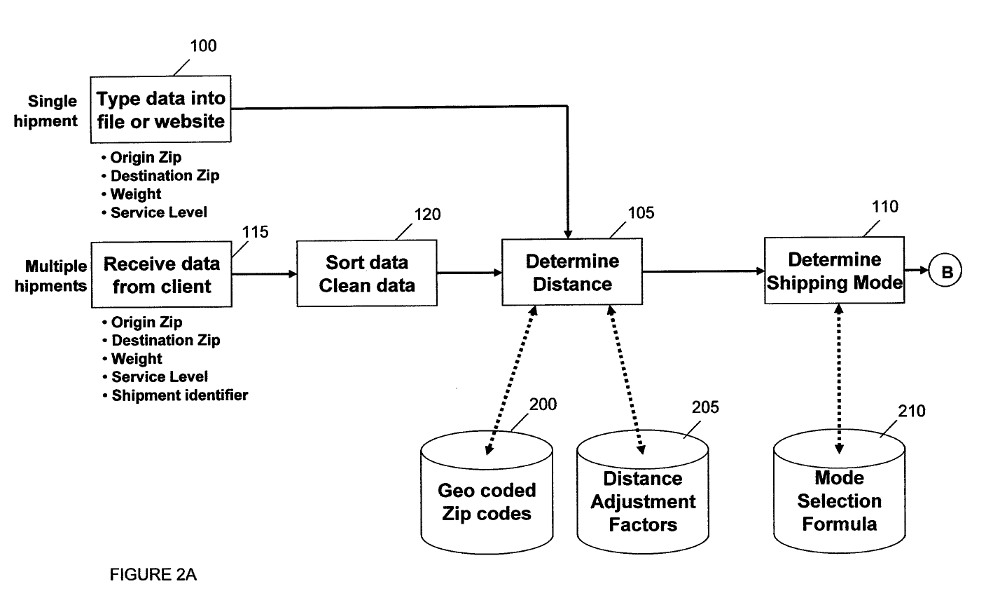

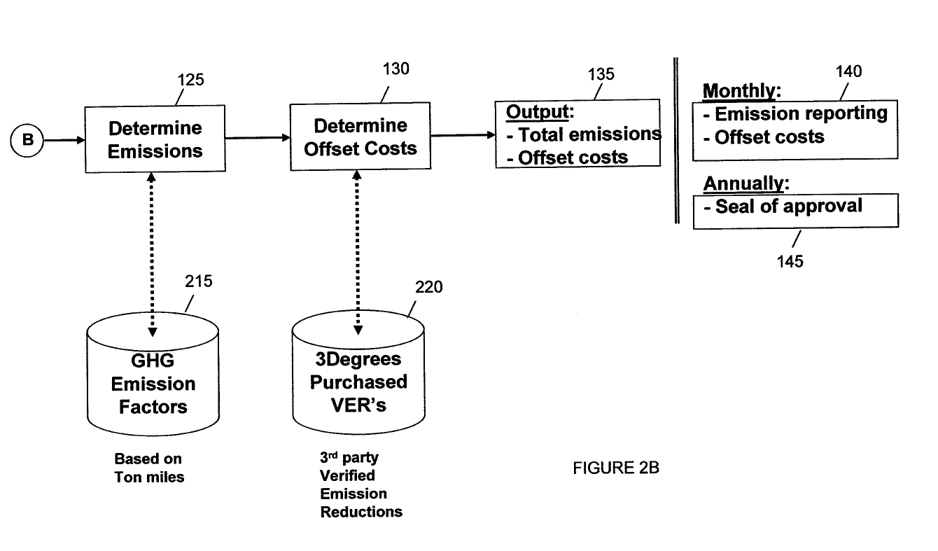

FIGS. 2A and 2B are flow diagrams comparable to FIGS. 1A and 1B, but showing additional data resources. At step 105, a database 200 for acquiring geo-coded zip codes is shown. This database 200 may be maintained separately and accessed remotely by a third party. Also, an electronic database 205 is shown for acquiring and updating distance adjustment factors. At step 110, an electronic database 210 is shown for accessing and maintaining mode selection formulas used to determine shipping modes. As shown associated with step 125, an electronic database 215 for GHG emission factors may provide data to ascertain emission factors based on ton miles. Associated with step 130, an electronic database 220 representative of third party VERs is shown; these VERs may be purchased to aid in offsetting greenhouse gases. Although separate databases are shown, more databases may be used or the databases may be combined.

The process performed according to the principles of the invention includes providing for determining emissions of Greenhouse gases, including carbon dioxide, measure in CO2 equivalents for shipping applications and may include computing carbon emissions based on specific conditions associated with each shipment and may determine offset reductions to be allocated. The use of such a process may aid businesses turning their supply chain “carbon neutral”.

The process may also provide trade-off analysis to permit comparison of one mode of shipment to another to determine the mode that has the least carbon emission footprint. For example, the process may compute the emission costs for transport from an origination point on the west coast to a destination on the east coast of the United States by rail, truck and ship (perhaps through the Panama Canal, for instance). The choice by a shipper (or destination consumer) of the shipment mode may be swayed based on the resulting trade-off carbon emission analysis.

Table 1 below shows a list of various modes of transportation for which carbon emissions may be calculated based on principles of the invention, along with exemplary characteristics that may be taken into account (but not necessarily required) when calculating the carbon emissions, and/or comments related thereto. In many cases, shipments utilize multiple modes, particularly for pick-up or delivery legs.

TABLE 1

| MODE | CHARACTERISTICS/COMMENTS |
|---|---|
| Domestic Truck LTL | Base calculation on origin zip, destination |
| (less than truckload) | zip, weight and distance factor. |
| Domestic Truck FTL | Base calculation on origin zip, destination |
| (full truck load) | zip, weight and distance factor. |
| Domestic Air | Short, medium, long distance. With/without |
| | truck pick-up/delivery. |
| Domestic Rail | Base calculation on origin zip, destination |
| | zip, weight and distance factor; distance |
| | factor based on rail network density and |
| | number of inter-modal depots per state. |
| Domestic Ocean | Map harbor to harbor with nautical distances; |
| | 20′/40′ container discrimination; inland haul; |
| | pick-up delivery. |
| International Rail | Base calculation on origin zip, destination |
| | zip, weight and distance factor. |
| International Ocean | Pickup (truck); assign zip codes to ports, |
| | GPS distance; port to port distance in |
| | nautical miles. |
| International Air | Pick-up/delivery truck; GPS distance; airport |
| | to airport distance in miles. |

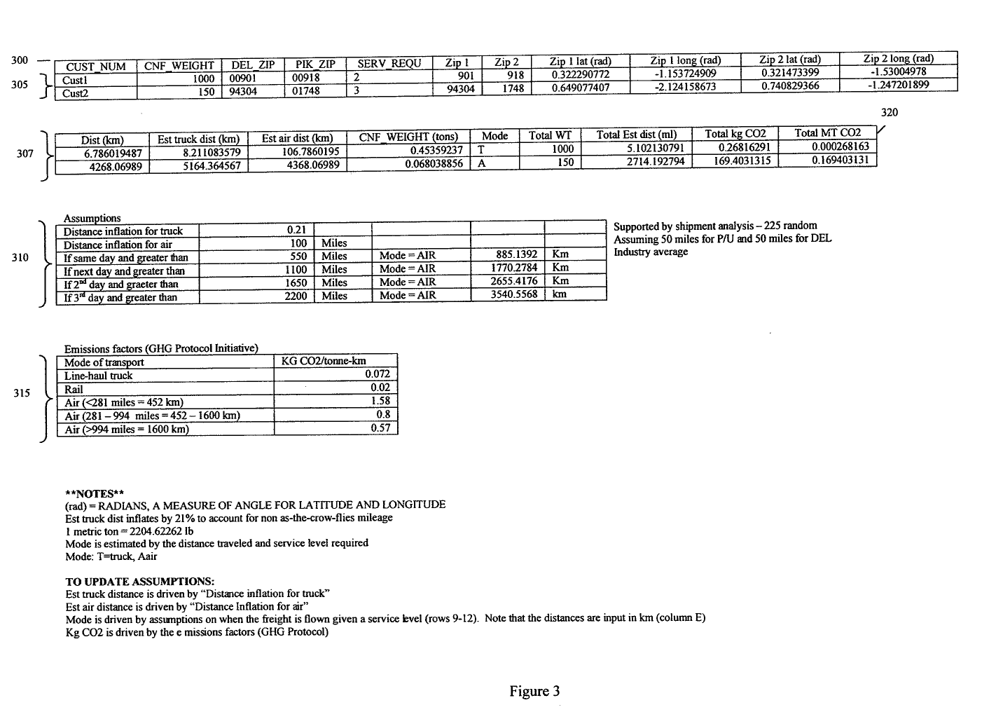

FIG. 3 is an exemplary output of a carbon calculator configured to calculate emissions and related offset costs according to principles of the invention. The output 300 generally may include several parameters: customer name(s) 305, confirmed chargeable weight (CNF_WEIGHT, the greater of either real weight and dimensional weight), delivery zip code (DEL_ZIP), pick-up zip code (PIK_ZIP), service level requirements (SERV_REQU), distance (dist (km)), transportation mode (Mode), Total weight (lbs), Total estimated distance (mi), Total kg CO₂, and Total metric tons CO₂. The output 300 may also include a distance calculation section 307, for air and truck.

Assumptions 310 used by the calculator may include distance inflation for truck delivery of 21% and distance inflation for air of 100 miles. Also, base rules may be assumed for calculations including the following. If the level of service desired is the same day and the distance is greater than 550 miles, then the transportation should best be by air. If the level of service desired is next day and greater than 1100 miles, the transportation should best be by air. If the level of service requested is 2^{nd} day delivery and the distance is greater than 1650 miles, then the transportation should best be by air. If the level of service requested is 3^{rd} day delivery and the distance is greater than 2220 miles, then the transportation should best be by air. (Note the distance thresholds may vary as cost and delivery time frames may vary from time to time in the transportation industry). Exemplary emission factors 315 for various modes of transport are also shown in kg CO₂/tonne-km.

As further shown in FIG. 3, the calculator may calculate the total metric tons of carbon dioxide 320 for each customer using the parameters shown. For example, the calculated total carbon dioxide in metric tons for the shipment for “Cust1” would be 0.000268163. For Cust2 the result would be 0.169403131. The results of the calculations may be stored in a computer database for eventual recall and use.

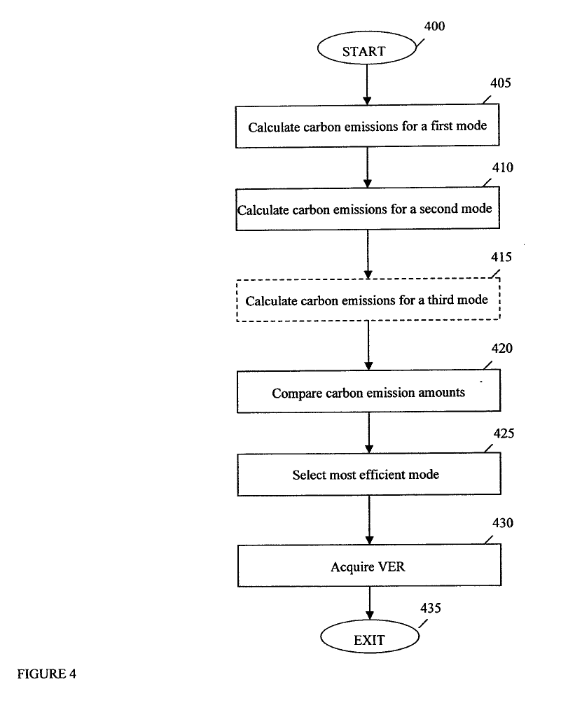

FIG. 4 is a flow diagram showing steps of an exemplary process performed according to principles of the invention, starting at step 400. At step 405, carbon emissions may be calculated using a database of carbon emissions for a first mode of transportation (e.g., one of: air, truck, rail, boat, and the like) based on determined carbon emissions for the first mode. The emissions (for all modes) may be calculated based at least in part on determined carbon emissions, on mileage (perhaps determined in part by GPS point to point, or actual mileage), weight, and perhaps based on distance adjustment factors. At step 410, carbon emissions may be calculated for a second mode of transportation. At optional step 415, carbon emissions may be calculated for a third mode of transportation. At step 420, a comparison may be performed to determine the most suitable mode of transportation based at least in part on the calculated carbon emissions for each mode. At step 425, a preferred or most efficient mode (which may be a combination of modes) may be selected for transportation. At step 430, a VER (carbon offset) may be acquired and optionally billed to a customer for a shipment. At step 435, the process exits.

The process of FIGS. 1A, 1B, 2A, 2B and 4 may be performed by execution of the respective components on a suitable local or remote computing platform including a server that may provide access to a user for initiating execution of the steps of the process by way of a web site, in accordance with principles of the invention. Alternatively, the steps of the processes may be performed on a local computer (local to a user) that executes the steps of the process, in accordance with principles of the invention. Moreover, the components may be combined into fewer or additional components and/or separated logically and/or physically.

While the invention has been described in terms of embodiments, those skilled in the art will recognize that the invention can be practiced with modifications and in the spirit and scope of the appended claims.

What is claimed is:

1. A computer-implemented method for computing carbon emissions for transporting a shipment, the method comprising the steps of:
calculating carbon emissions for a first mode of transportation by accessing a database configured to store at least carbon emission related data;
determining a carbon offset cost for the first mode of transportation and updating the database; and
outputting total emissions and offset costs for the first mode of transportation to provide a basis to reduce the effects of carbon emissions for the first mode of transportation.

2. The computer-implemented method of claim 1, further comprising the steps of:
determining a distance from a point of origin and a destination; and
determining the first mode from among a plurality of modes of transportation based on the determined distance.

3. The computer-implemented method of claim 2, wherein the step for determining the distance includes determining a point to point mileage, being converted to actual mileage.

4. The computer-implemented method of claim 2, wherein the step of determining the distance includes determining distance using global positioning system (GPS) data between the point of origin and the destination.

5. The computer-implemented method of claim 1, further comprising computing a monthly total emissions and monthly offset costs.

6. The computer-implemented method of claim 1, further comprising acquiring a Verified Emission Reduction (VER) based on the determined carbon offset.

7. The computer-implemented method of claim 1, further comprising:
calculating carbon emissions for a second mode of transportation;
determining a carbon offset cost for the second mode of transportation; and
comparing the carbon emissions for the first mode and the carbon emissions for the second mode to determine a better mode of transportation.

8. A system to compute carbon emissions related to transportation of a shipment, the system comprising:
a distance determination module embodied in a computer system configured to determine a distance for a shipment between an origination and a destination using a computer database configured with distance data;
a transport mode selection module embodied in a computer system to distinguish between different transport modes; and
a carbon emission determination module embodied in a computer system configured to access the computer database and determine a carbon footprint for at least one selected transport mode based on the determined distance in the computer database and a weight of the shipment,
the computer database accessible by the distance determination module, the transport mode selection module and the carbon emission determination module,
wherein the carbon emission determination module updates the computer database with the carbon footprint to be used to assist in reducing carbon emissions.

9. The system of claim 8, wherein the distance determination module is configured to determine a distance using global positioning system (GPS) data.

10. The system of claim 8, wherein the distance determination module is configured to determine a distance using actual mileage traversed during shipment.

11. The system of claim 8, further comprising a comparison module is configured to compare carbon emissions of at least two modes.

12. The system of claim 11, wherein the comparison module is configured to select one transport mode over another transport mode based on the results of the comparing.

13. The system of claim 12, wherein the transport mode includes at least any one of: an air transport mode, a truck transport mode, a rail transport mode, or an ocean/barge transport mode.

14. The system of claim 8, wherein the carbon footprint is determined in total metric tons CO₂.

15. The system of claim 8, wherein the carbon emission determination module is configured to determine the carbon footprint using a service level parameter.

16. The system of claim 8, wherein the distance determination module, the carbon emission determination module and the carbon offset determination module comprise a carbon calculator.

17. The system of claim 8, further comprising an interface module configured to output the calculated carbon emissions and the determined carbon offset.

18. A system for computing carbon emissions for transporting a shipment, comprising:
a first component embodied as part of a computer system to calculate carbon emissions for a first mode of transportation by accessing an electronic database configured to store at least carbon emission related data;
a second component embodied as part of a computer system to determine a carbon offset cost for the first mode of transportation and updating the electronic database; and
the electronic database to store the total emissions and offset costs for the first mode of transportation and configured to be accessed to provide a basis to reduce the effects of carbon emissions for the first mode of transportation.

19. The system of claim 18, further comprising:
a third component to calculate carbon emissions for a second mode of transportation;
a fourth component to determine a carbon offset cost for the second mode of transportation; and
a fifth component to compare the carbon emissions for the first mode and the carbon emissions for the second mode to determine a better mode of transportation.
